(19) United States
(12) Patent Application Publication
(10) Pub. No.: US 2022/0215414 A1
(43) Pub. Date: Jul. 7, 2022

(54) Dynamic Content and Pricing

(71) Applicant: TILTING POINT MEDIA LLC, New York, NY (US)

(72) Inventors: J. Niklas Herriger, Brookyn, NY (US); Andre Cohen, New York, NY (US)

(73) Assignee: TILTING POINT MEDIA LLC, New York, NY (US)

(21) Appl. No.: 17/403,907

(22) Filed: Aug. 17, 2021

Related U.S. Application Data
(63) Continuation of application No. 16/883,840, filed on May 26, 2020, now abandoned.
Application No. 16/883,840 is a continuation of application No. 15/124,240, filed on Sep. 7, 2016, now abandoned.
(60) Provisional application No. 61/949,395, filed on Mar. 7, 2014.
(60) Provisional application No. 62/088,748, filed on Dec. 8, 2014.

(51) Int. Cl. G06Q 30/02

(52) U.S. Cl. CPC G06Q 30/0206; G06Q 30/0283

(57) ABSTRACT

According to an example for providing dynamic content and pricing, pricing data for at least one item accessible in a software application is loaded, and current profile data for an active user of the software application and historical profile data for a group of users is loaded. A behavior metric is calculated for the active user based on the current profile data of the active user and the historical profile data of the group of users, and a price for the at least one item for the active user is calculated based on the behavior metric. In another example, an item to offer a user is determined based on localization data, and in another example, a combination or sequence of items to offer is determined.

### CROSS-REFERENCE TO RELATED APPLICATIONS

This application is a continuation of application Ser. No. 16/883,840, filed May 26, 2020, which is a continuation of application Ser. No. 15/124,240, which is a national stage application under 35 U.S.C. § 371 of International Application No. PCT/US2015/019508, filed Mar. 9, 2015, which claims the benefit of U.S. Provisional Application Nos. 61/949,395, filed Mar. 7, 2014 and 62/088,748, filed Dec. 8, 2014, each of which is hereby incorporated herein by reference in its entirety.

### BACKGROUND

A significant share of computer software is now distributed through online application stores and available for download on a myriad of devices. Software applications may include features or components available for purchase within the application after an initial download, such as an “in-app” purchase. Software applications may also include or connect to a virtual economy, which may include virtual content or virtual goods. The pricing of an in-app purchase and/or virtual goods at any given time may influence the purchasing behavior of a software user. Similarly, content offered to a user at any given time as an in-app purchase or virtual good may also influence purchasing behavior.

### BRIEF DESCRIPTION OF THE DRAWINGS

FIG. 1 illustrates a network-based system for dynamically pricing an in-app purchase and/or virtual good (hereinafter collectively referred to as an “item”) and for providing dynamic content in a software application, according to an example of the present disclosure;

FIG. 2 illustrates a flowchart of calculating an item price based on historical profile data and a behavior metric, according to an example of the present disclosure;

FIG. 3 illustrates a flowchart of determining an item to offer and calculating an item price based on historical profile data and localization data, according to an example of the present disclosure;

FIG. 4 illustrates a flowchart of determining a combination or sequence of items to offer a user based on historical profile data, and calculating an item price for the combination or sequence, according to an example of the present disclosure; and

FIG. 5 illustrates a schematic representation of a computing device that may be used as a platform for executing the steps of FIGS. 2-4, according to an example of the present disclosure.

### DETAILED DESCRIPTION

Examples of the present disclosure relate to the dynamic selection of content and dynamic pricing in software applications, such as those available for download from an online application store. Dynamic content and pricing may be calculated or determined based on the profiles or behavioral data of users of a software application, software environment, system, or ecosystem. More specifically, the key relationship between a user's application usage, e.g., the user's progress or state in an application or game, and the user's purchasing behavior may be analyzed and leveraged to optimize content and pricing presented to a user, and further refined in light of other trends such as market demands, competition, and geography.

Dynamic content selection and pricing may allow a software developer to offer a user the right price at the right time; the right product to the right user; and/or the right products in the right combination or sequence to optimize or maximize the purchasing of in-app purchases and/or virtual goods, with the goal of maximizing the lifetime value (hereinafter “LTV”) of the user.

Moreover, dynamically adjusting the content presented to a user and dynamically adjusting the price presented to the user, so that not every user sees the same content and/or the same prices, may increase engagement levels, lower churn or attrition rates, reduce pricing inefficiencies, convert players from non-paying or non-profitable customers into paying and profitable customers, and may generally increase user satisfaction and enjoyment of an application. Dynamic pricing and content also results in minimal risk to an application developer due to the real-time nature of pricing and content changes, allowing pricing and content changes to continuously update based on, e.g., results, user acceptance, A/B testing, and other metrics following changes in content and pricing on a per-user basis.

Dynamic content and dynamic pricing may present unique challenges and opportunities in the field of software applications, systems, and ecosystems. For example, a software application comprising virtual goods and/or in-app purchases may allow a software developer to offer an infinite supply of such items, requiring different approaches to dynamic pricing from those industries with supply chain constraints, such as production, transit, and storage costs, and allowing software developers to introduce dynamic content and dynamic pricing in a single application.

In general, the distribution of software has expanded from distribution on physical media to distribution over networks such as the internet, including through online application stores, app stores, or digital stores operated by various distributors. Electronic devices connected to the internet, or to other public or private networks, such as computers, servers, mobile phones, tablet computers, televisions, gaming consoles, home appliances, and other consumer electronics devices (hereinafter, simply “device” or “devices”) may connect to digital stores to download software, software updates, and software components. Similar examples may be found in the commercial and industrial sectors, such as with point-of-sale systems or industrial control devices.

Such devices, whether in the consumer, commercial, or industrial sector, may contain software pre-installed by a device manufacturer, or software installed at a later time by a purchaser or user. For example, a device may be shipped with an operating system and a base install of software applications (hereinafter an “application” or “app”) which may be, e.g., software for purchasing music, watching videos, monitoring stocks, or checking the weather. A user of the device (hereinafter “user”) may subsequently download additional apps from a digital store which may be, for example, apps for education, finance, gaming, social networking, sports, travel, or other interests. Software applications or “apps” may also include websites, web applications, applets, or other software that is hosted remotely from an end-user device.

In some examples, the digital store may be configured to sell or license applications, or provide software under any other commercial or non-commercial mechanism such as a trial period, freeware, freemium, shareware, or open source offering (hereinafter referred to interchangeably as a “purchase” or “download”). Apps may be pre-installed or downloaded either as a single component, or as modularized components. In either case, apps may allow for functionality or features to be selectively enabled or disabled based on certain criteria, e.g., a user purchase, an upgrade, an achievement, or other criteria based on the user or the app itself. Apps may include a virtual economy, in-app purchase options, or both.

In an example of an app comprising or connected to a virtual economy, users may earn virtual currency, virtual money, or soft currency and exchange the virtual currency for virtual goods. Virtual currency may be an unregulated, digital currency issued and controlled by developers of an app or community, and used and accepted among the members of a specific virtual community.

Examples of virtual currencies may include coins, gems, diamonds, gold, silver, stars, virtual dollar notes, casino chips, tokens, ribbons, bullets, materials, crops, prestige levels, experience points, or hints. In some examples, time may also be a virtual currency, broken down into units such as seconds, minutes, hours, days, weeks, months, or years.

[symbol]

Examples of virtual goods may include non-physical or intangible objects purchased or downloaded for use in games, apps, websites, marketplaces, online communities and/or online games. Virtual goods may be non-consumable in that they are available to be used once, such as characters, avatars, vehicles, weapons, buildings, structures, tools, engines, and clothing. Virtual goods may also be consumable in that they may be stored in an account or storage to be used over time, such as ammunition, bullets, bombs, rockets, fuel, energy, time (e.g., minutes or hours), “retries” or “continues” (allowing the user to play another round).

Virtual goods may also be sold in subscription form, where the user's ability to use a good is based on a subscription model of a pre-set time, or virtual goods may be coupled with a rewards program. In an example, a rewards program may be a structured marketing effort that rewards, and therefore encourages, loyal buying behavior that is potentially beneficial to a company. Rewards programs may be referred to as loyalty programs, pay back programs, points programs, advantage programs, mileage programs, or club programs. Examples of rewards programs may include those offered by airlines, trains, cruise lines, hotels, gas stations, credit cards, brick and mortar stores, online stores, and/or restaurants.

As one example in the gaming context, a user may earn a virtual currency such as coins or points during gameplay that can be exchanged in a virtual store for goods. A virtual economy may be critical for motivating a user to continue gameplay, and may be particularly important in games that use a “freemium” model where basic features in an app are provided for free, with an upcharge for advanced features, functionality, or virtual goods.

In some examples, a developer may allow a user to exchange real currency for virtual currency, such as the real currencies of the United States Dollar, the Euro, the British Pound, the Japanese Yen, or digital currencies or cryptocurrencies such as Bitcoin, or other mechanisms for conducting transactions or micro-transactions. In this example, in the gaming context, a user may pay a fee in real currency to unlock virtual currency that can then be used to exchange the virtual currency for virtual goods in a virtual economy or virtual store. In other words, a user may bypass the need to earn virtual currency by purchasing it with real currency.

In an example of an application comprising an in-app purchase option, the in-app purchase may be a feature or component, or combination of features or components, that a user may unlock or download in exchange for real currency. As an example in the gaming context, a user may pay a fee in real currency to unlock new levels or power-ups. In contrast to a virtual economy which may be managed by an app developer, in-app purchases may be facilitated by an app store. For example, a user may have an account with an app store linked to a credit card or gift card, and may be required to login with a password or biometric to the app store to make an in-app purchase through the app store ecosystem.

Both virtual goods and in-app purchases present possible revenue streams for application developers. As one example, app developers may generate revenue from actual cash purchases in real currency through the purchase of an in-app purchase, e.g., by exchanging real currency for virtual currency. As another example, app developers may generate revenue from motivating the continued use of an application, e.g., through building user interest by way of virtual economies to increase user engagement and immersion, which in turn may drive more app downloads, app upgrades, virtual currency purchases with real currency, and in cases where apps are advertisement-supported, increased ad traffic and ad revenue.

No matter the source of revenue, app developers may seek to prevent churn or attrition, i.e., to minimize the number of users who stop using an app over a given period of time, and to increase or at least stabilize user engagement in the app. App developers presently lack systems and methods for understanding how and when users earn and spend virtual currency, how individual virtual goods are performing, how virtual goods and in-app purchases should be priced, combined, and/or sequenced, and what other metrics can be used to optimize virtual economies and in-app purchases based on an understanding of the relationship between player data and user purchasing behavior.

As one example in the gaming context, an app developer may seek to determine whether a power-up for a character to gain extra speed should cost 1,000 in virtual currency (e.g., 1,000 coins, diamonds, or other examples of virtual currency) or 2,000 in virtual currency, and whether the power-up should be offered within the first 5 minutes of gameplay or the first 10 minutes, or when the player reaches a certain level. As another example, an app developer may seek to determine whether a direct purchase of the power-up, or the required amount of coins (the exemplary 1,000 or 2,000 coins) equivalent to the power-up, should cost $1 USD or $2 USD as an in-app purchase.

According to an example for providing dynamic content and pricing, pricing data for at least one item accessible in a software application is loaded, and current profile data for an active user of the software application and historical profile data for a group of users is loaded. A behavior metric is calculated for the active user based on the current profile data of the active user and the historical profile data of the group of users, and a price for the at least one item for the active user is calculated based on the behavior metric and/or historical profile data. In another example, an item to offer a user is determined based on localization data, and in another example, a combination or sequence of items to offer is determined. In some examples, more than one behavior metric may be calculated, and as discussed below, a price may be calculated for a group or cluster of users.

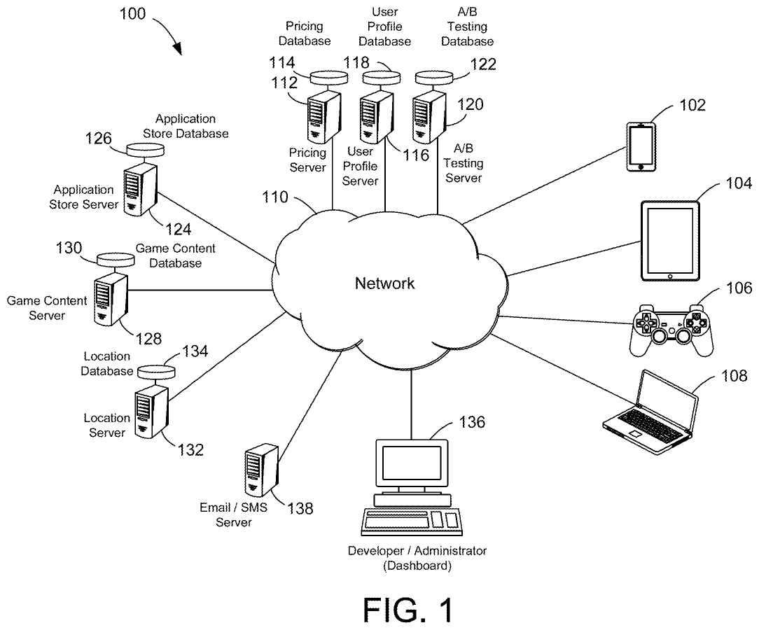

FIG. 1 illustrates a network-based system or “ecosystem” 100 for dynamically pricing an in-app purchase and/or virtual good and providing dynamic content, according to an example of the present disclosure. In an example, devices 102-108 represent user devices, such as smartphone 102, tablet 104, gaming console 106 (or other mobile or non-mobile gaming or computing platforms), and laptop (or desktop computer) 108. Devices 102-108 may include or execute at least one app downloaded from an app store, discussed in more detail below. In another example, apps may be streamed or otherwise transmitted via a network connection to a device or terminal, e.g., a web browser or thin client, where the software is not installed and/or locally stored.

Apps installed on devices 102-108 may also include, embed, or access a software development kit (“SDK”) or portions of an SDK or code libraries (or an application programming interface, discussed below) enabled to provide functionalities related to the systems and methods described herein. The SDK or code libraries may be optimized to require a minimal amount of storage space to allow apps to remain small and downloadable over-the-air, e.g., without a WiFi connection and within the limits of a carrier cap for over-the-air downloads. Similarly, the SDK or code libraries may be optimized to be as computationally efficient as possible to not have app performance affected by the SDK functionalities, e.g., to not affect app loading, frame rates, etc. The SDK may be transparent to the user, to not affect the visual integrity of an app.

In some examples, the SDK may make prices and content accessible to an app, notify the app of changes in prices and content, and communicate price and content changes to the user via a user interface element such as pop-up alerts, message boxes, on-screen buttons, or push notifications. In an example of a racing game, the SDK may be responsible for updating the availability of in-app purchases or virtual goods such as additional cars, additional race tracks, additional drivers, different tires, different suspensions, improved turbochargers, bigger wheels, better brakes, more fuel, higher top speeds, faster or easier cornering, and other non-consumables or consumables, as well as the prices of such items at any given time.

It will be appreciated that, in some examples, an application programming interface (“API”) may be used in place of, or in conjunction with, an SDK. For example, an app developer may program certain software calls to a server through an API using supplied URL specifications.

Ecosystem 100 may also include an application store server 124 and database 126, such as the app store discussed above for distributing software under any commercial or non-commercial mechanism. The application store server may allow users of devices 102-108 to browse available applications for download, and may also store information related to in-app purchases and/or virtual goods.

Ecosystem or “software environment” 100 may also include a game content server 128 and database 130, which may include data related to the actual content of a game or application, such as levels, items, characters, and other parameters affecting gameplay or application use.

Location server 132 and database 134 may receive or store information related to the geographical locations of users. For example, location database may store that a particular user is located in a particular country, in a particular state or province, at a particular latitude or longitude, or even at a particular neighborhood or street address. Location database 134 may also store information related to or derived from location data, such as a language that a particular user speaks or is likely to speak, or data related to user preferences in a particular location, such as a preferred application type, preferred in-app purchase, preferred virtual good, or combinations thereof, or preferred pricing levels or sensitivities.

Pricing server 112 and database 114 may store pricing information related to applications, such as the pricing for the app itself, in-app purchases, and virtual goods in the app, both in current form and historical form. In some examples, pricing server 112 may comprise detailed data on an entire virtual economy of an app. Data may comprise an identifier, a textual description, whether a virtual good or in-app purchase is consumable, an initial price or value, and/or other information related to an item. Changes to pricing server 112 may be communicated to application store server 124, or vice versa, or to a server for presenting the prices in a virtual economy and/or to devices 102-108.

Pricing server 112 may also include a dynamic pricing and content engine. The engine may collect various inputs, as discussed below in more detail; filter out inputs due to a lack of information, irrelevancy, a suspicion of inaccurate data, or a developer or user opting out; and combine inputs into, for example, a vector format such that every input is represented as a scalar value.

The engine may also apply a model as discussed below to output dynamic pricing, e.g., a positive or negative alteration to a default or current price, and content updates, e.g., which content to offer, for either a user or groups of users. As discussed below in more detail, the various models may be trained based on data for a single user or a group of users, including historical data, current data, other inputs, or a combination thereof. In the event that more than one model is applied, the final output or outputs may be balanced by weights such that each model receives a specific amount of importance.

User profile server 116 and user profile database 118 may include general user profile information, such as name, age, gender, app preferences, network carrier, and device type, as well as detailed behavioral data derived from application usage. In the example of a game, user profile server 116 may store game state and behavioral data such as player progress, levels, remaining lives, and other state and time data, as well as purchase information for in-app purchases and virtual goods.

In some examples, game state data may be represented as a decision tree or log of player behavior or progress in a game, and may be coupled with timing information of, e.g., gameplay, app usage, and in-app purchases or virtual good purchases for that user, to be used to predict future behavior of other users, as discussed below in more detail. In some examples, data may be stored as or converted into time series data.

In some examples, user profile server 116 may also store event data related to counts of the number of players that have generated an event of a specific name. For example, the numbers of players that have purchased a specific in-app purchase at a specific time or game state, or the numbers of players that have purchased a specific virtual good in a specific place, may be counted. In-app purchases and virtual goods purchased within a time period of a week, a month, or a year, for example, may also be averaged.

Data stored on user profile database 118 may be complete or incomplete sets of data based on the different usage behaviors of app users, e.g., users who engage in a game for short periods of time before jumping to another game. Data may also be received or stored out of chronological order. Techniques to normalize or reduce computational overhead and cost, including financial cost, may be employed with respect to the data stored on user profile database 118. For example, if 70% of a data set were analyzed on Day 1, and the remaining 30% arrive on Day 2, in examples, the 70% analysis and the 30% analysis would be merged rather than conducting a 70% analysis on Day 1, and a 100% analysis on Day 2, thereby calculating the original 70% twice.

Data stored on user profile database 118 may be received from, e.g., devices 102-108. Data may be pulled or pushed from a device upon launching an app on a device, upon reaching a specific point in an app, e.g., a level, or at pre-set time intervals, etc. Alternatively, data may be pulled or pushed only when device resources are available, i.e., when the push or pull routine will not negatively affect app performance or gameplay. In some examples, data may also be pushed or pulled only when an internet or network connection is detected, or when a minimum bandwidth requirement is met.

A/B testing server 120 and database 122 may store data relating to various options that may be presented, or were presented, to users during A/B testing, as well as the results of A/B testing. In various examples, A/B testing may be used to determine optimal pricing and/or content to offer a user, and may be coupled with the dynamic content and pricing described herein. Various techniques, such as those related to the multi-armed bandit problem, may be utilized to determine which prices to test, when to stop testing prices for a group of players, and which price is optimal.

Developer or administrator computer 136 may be a computer, such as a desktop computer, for displaying a dashboard or portal to report information related to dynamic content and pricing to an app developer, such as the information stored on pricing database 114, user profile database 118, and A/B testing database 122. The dashboard may also report on other metrics useful to an application developer, such as organic virtual currency acquisition data, spending behavior, performance of individual virtual goods and in-app purchases, and player engagement, churn, or attrition.

In an example, e-mail/SMS server 138 may also be used to dispatch reports to app developers and other parties granted access to such information. For example, a daily e-mail may be dispatched to application developers including a “roll-up” of pricing or content changes or determinations made on a given day for a given user, user type, or groups of users.

The reports generated or displayed by computer 136 or e-mail/SMS server 138 may include current and historical information on a per-user or per-group basis for pricing of in-app purchases and/or virtual goods, or combinations or sequences of virtual goods offered to users to optimize revenue and user engagement. The reports may also include the results of dynamic pricing and content changes, as well as the results of A/B testing.

The devices and servers of FIG. 1 may be coupled by network 110, which may be any public or private network such as the internet or an intranet. It will be appreciated that the servers of FIG. 1 may be the same server, may be co-located servers, or may be remotely-located servers. Similarly, the databases of FIG. 1 may comprise a single database with multiple related tables, or separate databases co-located or located remotely of each other.

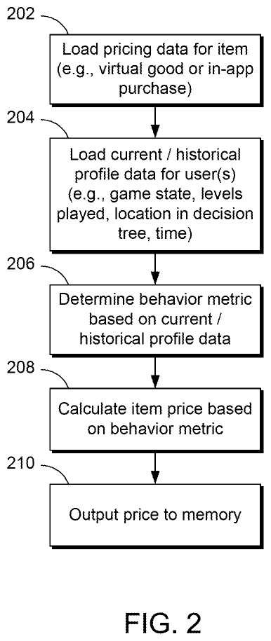

FIG. 2 illustrates a flowchart of calculating an item price based on historical profile data and a behavior metric, according to an example of the present disclosure. In block 202, in an example, pricing data may be loaded onto a processor. The pricing data may include pricing relating to a software application, software environment, or software ecosystem, such as pricing for a virtual good or goods in a virtual economy, an in-app purchase or purchases, or a combination thereof.

In block 204, current and/or historical profile data for a single user or group of users may be loaded. The data may include, generally, game state, game progress, levels played, rounds won, a state or location in a decision tree, time, virtual currency balances, and other factors relating to user behavior or progress. More specifically, the data may include a maximum level reached, a maximum speed reached, a maximum distance traveled, a longest period survived, a fastest lap time, a longest round played, a furthest or highest mission unlocked, a highest level unlocked, total money spent in a game, a total amount of virtual currency owned in a lifetime, goals scored, attempts per level, a best win-loss ratio accomplished, a number of badges earned, touchdowns scored, cars owned, houses bought, islands unlocked, mines operated, trees possessed, combos completed, experience gathered, real money spent, a number of different devices an app or game was played on, a number of social networks a user has an account for, a number of Facebook friends, a number of game-related wall posts, a number of ads clicked, a number of likes, a number of videos watched, a number of reviews left, and/or a number of challenges completed.

In block 206, a behavior metric or metrics for a user (or “active user,” i.e., the user currently being analyzed for dynamic pricing and content adjustments) may be calculated based on the current and/or historical profile data of the active user and/or other users. In one example, a behavior metric may be an engagement level based, e.g., on the frequency of actions of a user, while in another example, a behavior metric may be a percentage likelihood that a user is about to churn, e.g., leave an app and never return. In some examples, more than one behavior metric may be calculated for a single user, a group of user, or a cluster of users.

As one example, a first user (or groups of users or clusters) may be highly engaged, such as a serious or hard-core gamer playing a first-person war game, while a second user (or groups of users or clusters) may be only lightly engaged, such as a casual gamer playing a word game while also watching a television show, but engagement may not accurately predict churn, which may be a separate calculation.

The engagement levels and/or churn levels for an active user may be calculations or predictions based on, for example, historical data representing frequencies of action related to engagement, or how often or how many times a user or group of users perform a certain event before churning. For example, a calculation may predict that a user has an 80% chance of collecting 100 more coins before churning, or a 70% chance of collecting 110 more coins, and so on. In some examples, the current and/or historical profile data for users loaded in block 204 may be augmented with user engagement metrics, predictions or calculations of future actions, and/or other data related to market demands, competition, and geography, as examples. Access to engagement levels and/or churn levels may allow an app developer to take an action to prevent the player from churning or becoming less engaged, such as offering dynamic pricing or content.

More specifically, a user engagement level may represent or be based on a frequency of an action, such as a frequency of playing a level, a frequency of sessions per day, a frequency of buying a virtual good, a frequency of buying an in-app purchase, a frequency of re-trying a level after an unsuccessful attempt, a frequency of ad clicks per session, a frequency of special moves performed per lifetime, a frequency of sharing game progress on social media, and/or a frequency of earning badges.

A churn level may represent or be based on a calculated or predicted number of events, and/or type of events, expected to occur before a user's lifetime in an app reaches an end, and may be based on historical data. A churn level may therefore relate to, in some examples, the percentage likelihood that a user is about to stop using an app as calculated or predicted by a certain event or events having occurred a certain number of times, alone or in combination with other factors discussed herein.

As one example of a churn level, there may be a 50% likelihood of churn once a user reaches five game plays. Game plays may be the number of times a single game was played, the number of times the “play” button on a home screen of an app was pressed, the number of times a family of related apps from an app developer is played, or any other count related to game play or app usage, as examples.

As another example of a churn level, there may be a 90% likelihood of churn if a user does not buy a particular item or particular upgrade, e.g., a sword, during the first five minutes of gameplay. Churn may also be predicted or calculated based on a number of character changes, a number of vehicle upgrades, a number of levels unlocked, a number of farms purchased, and/or a number of battles won, as examples.

In block 206, as an example of calculating a behavior metric, the block may determine that a user is highly engaged based on the frequencies discussed above or other inputs such as the user's state, location, or status in a game or decision tree when compared to other users, i.e., based on a historical determination that users in a particular game state or location are highly engaged as discussed above. In another example, the calculation may determine that the user's location in a game is a point of frustration based on historical profile or behavioral data from other users, and/or event calculations discussed above, and a likely point of churn.

In other examples, the user's game state may show that the user has lost three rounds or lives in a row, and is likely to be reaching a state of churn, or that a user is visiting a website with a subscription model on a less frequent basis and is likely to abandon the subscription.

In block 208, an item price may be calculated based on the calculated behavior metric. For example, if a default price for all users of an in-app purchase or virtual good is $1, the price may be dynamically adjusted to $1.50 for a user that is highly engaged, or down to 50 cents for a user that is not engaged, or likely to churn. As discussed above, prices may be calculated per user, per group, or per cluster of users. In some examples, prices may first be calculated per group or cluster to enable quick testing of price changes.

As one example in the gaming context, an app developer may offer a power-up, e.g., an increased level of a character attribute such as extra strength, that is generally priced at 1,000 in virtual currency, e.g., 1,000 coins, diamonds, or other examples of virtual currency. The app developer may want to dynamically offer the strength power-up to weaker players for a lower price, e.g., 750 coins, in order to give them an advantage that compensates for their relative lack of skill, to make the game more fun for them and to prevent them from churning. At the same time, the app developer may choose to offer the exact same strength power-up to stronger, more skilled players for a higher price, e.g. 1250 coins, in order to make the game more challenging and motivating for those players.

As another example in the gaming context, an app developer may offer a speed power-up for a vehicle to gain extra speed that is generally priced at 50,000 in virtual currency, e.g., 50,000 gems or sapphires, or other examples of virtual currency. The app developer may want to offer the speed power-up at a lower price or even free of charge to players that have shown a high probability of churning or have a decreasing level of engagement with the game based on the number of game sessions played per day by that user decreasing from, e.g., 5 daily sessions to 1 daily session over the previous week, or an average gameplay session time decreasing from 10 minutes to 3 minutes over the course of 3 days. In contrast, a user with an increasing level of play or engagement, or decreasing likelihood of churn, may be offered the power-up at a higher price.

As another example in the gaming context, an app developer may offer an in-app purchase to players for 10,000 in virtual currency, e.g., 10,000 coins, diamonds, poker chips, gems or other examples of virtual currency in exchange for a default price of $9.99 in real currency. However, if a player has already spent real currency in the game or in other games and shown a willingness to spend real currency, the player may be considered price-insensitive, and the player may be offered only 8,000 coins for $9.99, or 10,000 coins for $14.99. As discussed above, if a player is about to churn or is showing decreased engagement based on historical data, the number of coins may be increased further, or the price may be decreased further or even set to zero.

As another example in the gaming context, an app developer may discount the price of an item if no purchase has been made during a given time period. For example, if a user has not made a purchase within the first hour, day, week, or other time interval of gameplay, pricing may be dropped for that user by 20% for at least one item.

In some examples, the app developer may place constraints on pricing changes. For example, the constraints may be upper and lower bounds for values, rounding of values to the nearest integer, rounding numbers to specific values such as prices ending with 99 cents in the United States, or distances from an original or default price value.

In block 210, the dynamic price (or prices) may be output to a memory and/or transmitted to, e.g., application store server 124 or other server responsible for communicating prices to a user, app, or virtual economy.

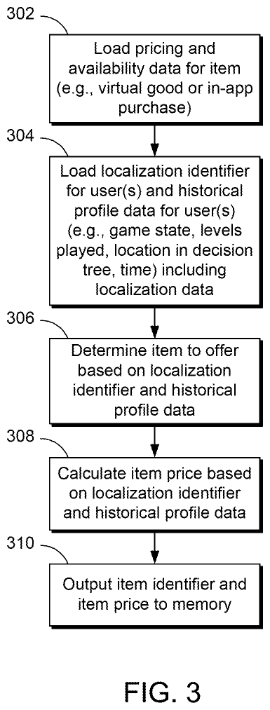

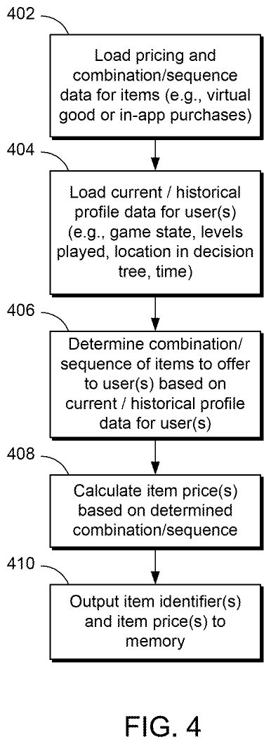

The flow of FIG. 2 (and FIGS. 3 and 4 as discussed below) may loop or repeat as a user continues to use an app to ensure that content and pricing at any given time are always optimized. Moreover, the flow of FIG. 3 may be set to loop or repeat after a given time period following a previous change to content or pricing offered to a user, in the event that the content or pricing change did not have a desired effect in a given time period.

FIG. 3 illustrates a flowchart of determining an item to offer and calculating an item price based on historical profile data and localization data, according to an example of the present disclosure.

In block 302, in an example, pricing and availability data may be loaded onto a processor. The pricing data may include pricing for items, as discussed above, and availability data, which may include data related to item types or variations available at any given point during application usage or gameplay. For example, availability data may indicate that a soccer game is to offer a certain type of soccer ball in various color combinations, such as red, black, and yellow; red, green, and yellow; or blue and white.

In block 304, a localization identifier for an active user(s) or user device(s) is loaded, along with current and/or historical profile data for users including localization data. For example, an active user may be identified as being in the United States, while the historical profile data may include data for users in the United States and other countries around the world. The data may also include game state, levels played, location in a decision tree, time, and other factors discussed above relating to user behavior, grouped by geographical location, as well as information including weather, holidays, country spending habits, geographical trends, and other metrics.

In block 306, an item to offer an active user is determined based on the localization identifier and current and/or historical profile data including localization data. For example, a determination may be made to offer a user in Germany a soccer ball in red, black, and yellow, or to offer the user soccer balls in various combinations of colors, with the German soccer ball promoted to the top of a list, or highlighted as a thumbnail image in a larger size.

In block 308, an item price may be calculated based on the localization identifier and current/historical profile data, including localization data, and/or the availability and pricing data. For example, a determination may be made that a particular item, such as a sword, is highly popular in Switzerland, and the item price may be increased from a default price to a higher price for users in that location. In other examples, a determination may be made that users in Switzerland are generally less sensitive to price increases, and the item price may be increased based on that determination, alone or in combination with another factor.

Other factors related to location may also be used to determine price. For example, if a player is located in Japan, item prices may be increased on Saturdays and Sundays, whereas in Israel, item prices may be decreased on Friday evenings and Saturday mornings. If a weather input detects that it is raining in a particular area of Brazil, item prices may be increased until the rain ends.

In block 310, the item identifier and item price may be output to a memory and/or transmitted to, e.g., application store server 124 or other server responsible for updating, transmitting, or communicating prices to a user or virtual economy. It will be appreciated that blocks 306 and 308 may be carried out alone or in combination.

FIG. 4 illustrates a flowchart of determining a combination or sequence of items to offer a user based on current and/or historical profile data, and calculating an item price for the combination or sequence, according to an example of the present disclosure.

In block 402, in an example, pricing and combination/sequence data may be loaded onto a processor. The pricing data may include pricing for items, as discussed above, and combination/sequence data, which may include data related to item combinations or sequences available at any given point during application usage or gameplay. For example, combination/sequence data may indicate that a racing game can offer a combination of engine, suspension, and tire upgrades, and in various sequences, such as an engine turbocharger followed by a new engine exhaust system.

In block 404, current and/or historical profile data for users may be loaded. The data may include game state, levels played, location in a decision tree, time, and other factors relating to user behavior. The data may also include data related to combinations and sequences downloaded or purchased by past users.

In block 406, a combination or sequence of items to offer to users is determined based on current and/or historical profile data. For example, a determination may be made to offer a valuable combination of virtual goods to a user in a game state where users historically churn, i.e., a combination of engine and suspension upgrades, or a valuable engine upgrade followed by a valuable suspension upgrade if the user remains in a state indicating that churn is still likely.

In block 408, an item price or prices may be calculated based on the current and/or historical profile data. For example, a determination may be made that a particular user is not likely to churn, and that users in a particular game state are likely to purchase a particular combination of upgrades at that time. In such an example, the combination may be offered to the user at a higher than normal price.

In block 410, the item identifier, or identifiers for a combination or sequence of items, and an item price or prices may be output to a memory and/or transmitted to, e.g., application store server 124 or other server responsible for communicating prices to a user or virtual economy. It will be appreciated that blocks 406 and 408 may be carried out alone or in combination.

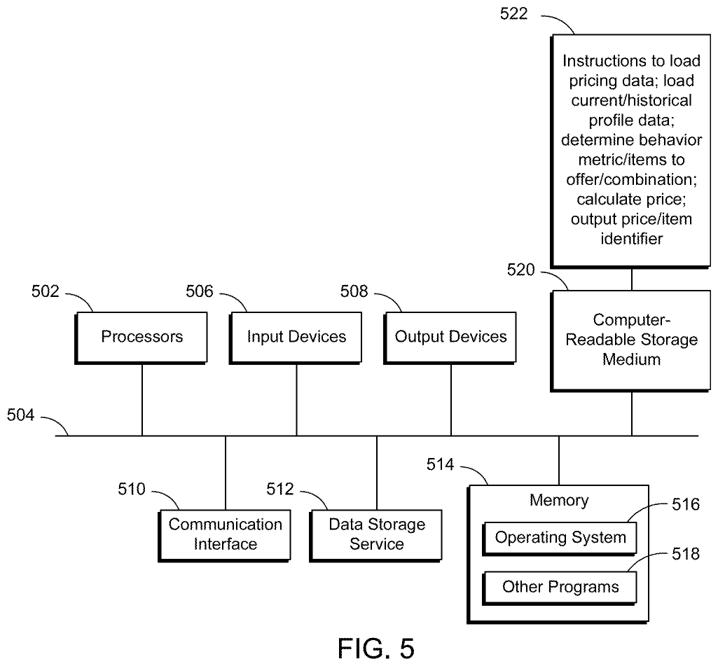

FIG. 5 illustrates a schematic representation of a computing device that may be used as a platform for implementing or executing at least one of the processes depicted in FIGS. 2-4 according to an example of the present disclosure.

In an example, device 500 comprises a processor or CPU 502, bus or other interconnect 504, input devices 506, output devices 508, communication interface 510, and data storage device 512. Device 500 may also include a memory 514, which may store an operating system 516 and other programs 518.

In some examples, device 500 may also comprise a non-transitory computer readable storage medium 520. More specifically, some or all of the operations set forth in the figures may be contained as a utility, program, or subprogram in any desired computer readable storage medium, or embedded on hardware. In addition, the operations may be embodied by machine-readable instructions. For example, they may exist as machine-readable instructions in source code, object code, executable code, or other formats. The computer readable storage medium may also store other machine-readable instructions, including instructions downloaded from a network or the internet. In an example, computer readable storage medium 520 may store instructions for carrying out the steps of FIGS. 2-4.

The computer readable storage medium may also store a firmware that may perform basic tasks such as recognizing input from input devices, such as a keyboard or a keypad; sending output to a display; keeping track of files and directories on a computer readable medium; and managing traffic on a bus. The network applications may include various components for establishing and maintaining network connections, such as machine readable instructions for implementing communication protocols including but not limited to TCP/IP, HTTP, HTTPS, Ethernet, USB, and FireWire.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method of providing dynamic pricing, comprising:
loading, on a processor, pricing data for at least one item accessible in a software application;
loading, on the processor, current profile data of an active user of the software application and historical profile data of a group of users of the software application;
calculating, on the processor, a behavior metric for the active user based on the current profile data of the active user and the historical profile data of the group of users;
calculating, on the processor, a price for the at least one item for the active user based on the behavior metric; and
outputting, to a memory, the price for the at least one item for the active user.

2. The method of claim 1, wherein the software application is communicatively coupled to a virtual economy.

3. The method of claim 1, wherein the item is a virtual good.

4. The method of claim 1, wherein the item is an in-application purchase.

5. The method of claim 1, wherein the behavior metric is an engagement level.

6. The method of claim 1, wherein the behavior metric is a churn level.

7. The method of claim 1, wherein the historical profile data of a group of users includes A/B testing data.

8. The method of claim 1, wherein the historical profile data of a group of users includes game state data and time data.

9. The method of claim 5, wherein calculating the price for the at least one item further comprises decreasing a current price of the item in the event that the engagement level is lower than a prior engagement level.

10. The method of claim 5, wherein calculating the price for the at least one item further comprises increasing a current price of the item in the event that the engagement level is higher than a prior engagement level.

11. A computing device comprising:
a processor;
a memory; and
a network interface,
wherein the network interface is to receive a localization identifier from a user device;
wherein the processor is to load availability and pricing data for at least one item in a software application and historical user profile data for a group of users grouped by location, and to determine an item and a dynamic item price to offer on the user device based on the availability and pricing data, the localization identifier, and the historical user profile data for the group of users; and
wherein the network interface is to output an item identifier associated with the item and the dynamic item price.

12. The system of claim 11 wherein the processor is to determine that an item is popular in a particular geographical location based on the historical user profile data.

13. The system of claim 11, wherein the processor is to determine the price sensitivity of a user based on the localization identifier and the historical user profile data.

14. A non-transitory computer readable storage medium on which is embedded a computer program, said computer program to provide dynamic content and dynamic pricing, said computer program comprising a set of instructions executable by a processor to:
load availability and pricing data for at least one item in a software application;
load historical application event data for a group of users and current application event data for an active user;
determine a combination of items to offer to the active user based on the historical application event data for the group of users and the current application event data for the active user; and
output at least one identifier associated with the combination of items and a dynamic price.

15. The non-transitory computer readable storage medium of claim 14, wherein the combination of items further comprises a sequence.
